(19) United States
(12) Patent Application Publication
(10) Pub. No.: US 2026/0194665 A1
(43) Pub. Date: Jul. 9, 2026

(54) Systems and Methods for Real-Time Detection and Elimination of X-Ray Bursts in Gamma Radiation Measurements

(71) Applicant: TARGET SYSTEMELEKTRONIK GMBH & CO. KG, Wuppertal (DE)

(72) Inventor: Jürgen Stein, Wuppertal (DE)

(21) Appl. No.: 19/264,540

(22) Filed: Jul. 9, 2025

Related U.S. Application Data
(60) Provisional application No. 63/669,407, filed on Jul. 10, 2024.

(51) Int. Cl. G01T 1/17; G01T 7/00

(52) U.S. Cl. CPC G01T 1/17; G01T 7/005

(57) ABSTRACT

A radiation detection device includes a gamma detector configured to receive a stream of non-random and random photon events and generate corresponding list-mode data, and a computing device in communication with the gamma detector configured to receive the list-mode data, determine, by applying at least one statistical timing analysis method to a segment of the list-mode data, data associated with the non-random photon events, predict, based on the data, a next non-random time window, and reject photon events that have arrival times, at the gamma detector, in the predicted non-random time window.

### CROSS-REFERENCE

The present application relies on, for priority, U.S. Patent Provisional Application No. 63/669,407, titled “Systems and Methods for Real-Time Detection and Elimination of X-Ray Bursts in Gamma Radiation Measurements” and filed on Jul. 10, 2024, which is herein incorporated by reference in its entirety.

### FIELD

The present specification is related generally to the field of illicit radioactive material detection. More specifically, the present specification is related to a gamma radiation detection system configured to detect and mitigate interference from X-ray bursts that arise from direct X-ray emissions, scattered radiation, and attenuated X-ray signals.

### BACKGROUND

It is necessary to scan cargo for illicit materials in order to enhance transportation security. Vehicle and cargo scanners use powerful X-rays to inspect trucks and containers. Gamma and X-ray photons are both forms of electromagnetic radiation, sharing similar properties and often occurring within the same energy spectrum. The names are derived exclusively from the mechanism by which the respective particles are generated. Gamma rays are emitted during nuclear processes (e.g., radioactive decay or nuclear de-excitation). X-rays are generated by electron interactions (e.g., bremsstrahlung or electron shell transitions), where electrons typically lose energy.

X-ray bursts typically arise from direct X-ray emissions, scattered radiation, and attenuated X-ray signals. Vehicle scanning machines, for example, generate periodic, high-intensity X-ray bursts with pulse frequencies ranging from 100 Hz to 500 Hz (bursts per second), with a burst duration of 1 to 5 microseconds per pulse, and a photon output of dense clusters (X-ray photo bunches) of high-energy X-rays emitted in rapid succession. These bursts produce two primary interference effects—namely, direct X-ray photons from the primary beam and scattered radiation in all directions.

Gamma and X-ray photons are indistinguishable by detectors since photons carry no information about their origin. A gamma detector in the vicinity of a scanner will more than likely count events at each burst time leading to high false alarm rates. In addition, “hard” X-rays (photon energies exceeding 10 keV) may originate from either nuclear or electronic sources, effectively blurring the line between gamma and X-ray classifications at higher energies.

It is therefore difficult to detect radioactive materials concurrently with X-ray scans. The periodic nature of high-energy X-ray bursts enables time-gated suppression of gamma detector signals during active X-ray emission windows. Typically, this is achieved by hard-wired or wireless inhibit signals which synchronize with X-ray burst cycles or a blanking protocol which temporarily disable the detector's data acquisition timed gate signals that are aligned with the bursts. The blanking protocol removes acquisition during X-ray bursts from the total measurement duration, introducing dead time into the scanning process, accounting for at least a few percent of the overall scan time. Dead time in the scanning process refers to the period immediately following the detection of a radiation event during which the detector and its associated electronics are disallowed from, or unable to, record another event. After registering a photon or particle, the system needs a short recovery time before it can accurately detect and process the next incoming event, during which time any radiation events that occur will not be counted, leading to a temporary loss of measurement capability and, potentially, an underestimation of the actual radiation present, leaving the detector “blind” to new events. In the remaining “post-gated” counts, only the gamma radiation of potential radioactive material is registered by the gamma detector, operating as if the environment is X-ray free.

Connecting the X-ray scanning systems and gamma detector systems, either wired or wirelessly, so that they are in electrical and data communication is not practical and often not possible at all. What is needed, therefore, is context-driven analysis that identifies radiation sources accurately. Further, there is a need for systems and methods that are configured to detect and mitigate interference from X-ray bursts that arise from direct X-ray emissions, scattered radiation, and attenuated X-ray signals that may interfere with sensitive gamma measurements. More specifically, there is need for systems and methods for real-time detection and rejection of X-ray bursts in gamma detector signals without the need for a gating signal.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards a gamma detection system, comprising: a gamma detector configured to receive a stream of X-ray and gamma photon events, wherein the gamma detector comprises a plurality of detector modules; at least one data acquisition system in data communication with each of the plurality of detector modules, wherein the at least one data acquisition systems is configured to generate list-mode data corresponding to the stream of X-ray and gamma photon events; a computing device in communication with the at least one data acquisition system, wherein the computing device comprises a processor and a non-volatile memory for storing a plurality of programmatic instructions which, when executed, cause the processor to: receive the list-mode data; apply at least one statistical timing analysis method to a segment of the list-mode data to determine at least first data and second data associated with X-ray photon events received at the gamma detector; tag the at least first data and second data with the X-ray photon events; predict, based on one of the at least first data and second data, a next time window of arrival of an X-ray photon event at the gamma detector; reject photon events that have arrival times at the gamma detector in the predicted time window; and output data indicative of gamma photon events.

Optionally, the at least one statistical timing analysis method comprises at least one of an autocorrelation method, a time-difference method, and a discrete Fourier Transform method.

Optionally, the first data is indicative of a frequency of the X-ray photon events and the second data is indicative of a phase angle of the X-ray photon events.

Optionally, when executed, the plurality of programmatic instructions cause the processor to determine the frequency and the phase angle by utilizing a power density spectrum of said segment of the list-mode data.

Optionally, the gamma detection system is a handheld device or a portable device.

Optionally, the X-ray photon events result from direct, scattered and/or attenuated X-ray bursts.

Optionally, the list-mode data comprises at least a first value indicative of photon energy and a second value indicative of a time of detection of a photon.

Optionally, the data acquisition systems comprise list-mode multi-channel analyzers.

Optionally, the segment corresponds to less than 1 second of the list-mode data.

In some embodiments, the present specification is directed towards a computer-implemented method of detecting and eliminating, in real-time, X-ray photon events from a stream of X-ray and gamma photon events arriving at a gamma radiation detector, wherein the gamma radiation detector comprises a plurality of detector modules and associated data acquisition systems, comprising: generating list-mode data corresponding to the stream of X-ray and gamma photon events, wherein the list-mode data is generated by the data acquisition systems coupled to the plurality of detector modules; receiving the list-mode data in a computing device that is in data communication with the gamma radiation detector; using the computing device, apply at least one statistical timing analysis method to a segment of the list-mode data in order to generate at least first data and second data associated with X-ray photon events received at the gamma radiation detector; tagging the at least first data and second data with data indicative of the X-ray photon events; predicting, based on one of the at least first data and second data, a next time window of arrival of an X-ray photon event at the gamma radiation detector; rejecting photon events that have arrival times at the gamma radiation detector in the predicted time window; and outputting data without said photon events.

Optionally, the at least one statistical timing analysis method comprises at least one of an autocorrelation analysis, a time-difference analysis, and a discrete Fourier Transform analysis.

Optionally, the first data is indicative of a frequency of the X-ray photon events and the second data is indicative of a phase angle of the X-ray photon events.

Optionally, the computer-implemented method further comprises determining the frequency and the phase angle by analyzing a power density spectrum of the segment of the list-mode data.

Optionally, the gamma radiation detector is configured as a handheld device or a portable device.

Optionally, the X-ray photon events result from direct, scattered and/or attenuated X-ray bursts.

Optionally, the list-mode data comprises at least a first value indicative of a photon energy of at least one of the X-ray photon events and a second value indicative of a time of detection of a photon from at least one of the X-ray photon events.

Optionally, the data acquisition systems comprise one or more list-mode multi-channel analyzers.

Optionally, the segment corresponds to less than 1 second of the list-mode data.

In some other embodiments, the present specification is directed towards a radiation detection device, comprising: a gamma detector configured to receive a stream of non-random and random photon events and generate corresponding list-mode data; a computing device in communication with the gamma detector, wherein the computing device includes a processor and a non-volatile memory for storing a plurality of programmatic instructions which, when executed, cause the processor to: receive the list-mode data; cause at least one statistical timing analysis to be applied to a segment of the list-mode data to determine a first data and a second data associated with the non-random photon events; predict, based at least on the first data and the second data, a next non-random time window; and reject photon events that have arrival times at the gamma detector in the predicted non-random time window.

Optionally, the at least one statistical timing analysis comprises an autocorrelation analysis, a time-difference analysis, and a discrete Fourier Transform analysis.

Optionally, the first data is indicative of a frequency of the non-random photon events and the second data is indicative of a phase angle of the non-random photon events.

Optionally, the frequency and phase angle are determined by analyzing a power density spectrum of the segment of the list-mode data.

Optionally, the radiation detection device is a handheld device or a portable device.

Optionally, the non-random photon events correspond to direct, scattered and/or attenuated X-ray bursts, and wherein the random photon events correspond to gamma radiation.

Optionally, the list-mode data comprises at least a first value indicative of photon energy of the non-random photon events and a second value indicative of a time of detection of a photon of the non-random photon events.

Optionally, the segment corresponds to less than 1 second of the list-mode data.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A shows a perspective view of a non-limiting exemplary scanning environment, in accordance with some embodiments of the present specification;

FIG. 1B is a block diagram showing a portion of the scanning environment of FIG. 1A, in accordance with some embodiments of the present specification;

FIG. 2 is a graph showing digitized current pulses corresponding to X-ray and gamma photon events, in accordance with some embodiments of the present specification;

FIG. 3 shows a first spectrum and a second spectrum having a plurality of vertical lines each, which are indicative of gamma and X-ray photon event arrivals, in accordance with some embodiments of the present specification;

FIG. 4 is a graph illustrating an identification of a burst frequency f=1/(burst period) from an autocorrelation of count samples, in accordance with some embodiments of the present specification;

FIG. 5 is a graph showing a distribution of consecutive event times, in accordance with some embodiments of the present specification;

FIG. 6 is a histogram showing the difference between arrival time tν and the 7th next event tν+7, in accordance with some embodiments of the present specification;

FIG. 7 is a graph showing a distribution indicative of cross-correlation of a measured pattern ‘h’ with a constructed pattern ‘k’ in accordance with some embodiments of the present specification;

FIG. 8A is a first graph of five seconds of multi-channel scaling (MCS) data, showing mechanically chopped ²⁴¹Am gamma radiation (or periodically modulated gamma emissions) at a frequency of 100 Hz, in accordance with some embodiments of the present specification;

FIG. 8B is a second graph using the auto-covariance of mechanically chopped ²⁴¹Am gamma radiation (or periodically modulated gamma emissions) at a frequency of 100 Hz, in accordance with some embodiments of the present specification;

FIG. 8C is a third graph showing a periodogram of mechanically chopped ²⁴¹Am gamma radiation (or periodic modulation of gamma emissions) at a frequency of 100 Hz, in accordance with some embodiments of the present specification;

FIG. 9 is an illustration of a modified table saw operating as a 100 Hz beam chopper of ²⁴²Am 60 keV gamma radiation, in accordance with some embodiments of the present specification;

FIG. 10 is a diagram of a wheel with 6 equidistant slots used as a 300 Hz beam chopper, in accordance with some embodiments of the present specification;

FIG. 11 is a graph showing a count rate distribution, further illustrating the separation of pulsed ²⁴¹Am gamma radiation from the background, in accordance with some embodiments of the present specification; and

FIG. 12 is a flowchart of a plurality of steps of a method for detecting and eliminating X-ray photon events from a stream of X-ray and gamma photon events arriving at a gamma radiation detector, in accordance with some embodiments of the present specification.

### DETAILED DESCRIPTION

The present specification describes systems and methods for enabling the real-time differentiation of X-ray bursts from gamma radiation during target security scanning, eliminating the need for direct coordination between X-ray scanners and gamma detectors. Thus, the present specification aims to enhance the detection of illicit radioactive materials using a gamma detector without the need for direct communication between an X-ray generator, of an X-ray scanner, and the gamma detector. The systems and methods of the present specification support autonomous identification of the timing of X-ray bursts by using at least one of a plurality of statistical timing analysis methods, including time-difference analysis, autocorrelation, and discrete Fourier transform. By employing list-mode data acquisition, photon arrivals are captured and accurately timestamped, allowing for the reconstruction of X-ray event timing and the effective elimination of X-ray interference from gamma measurements.

The systems and methods of the present specification operate independently of hard-wired or wireless synchronization signals from the X-ray generator, overcoming logistical and technical constraints. The disclosed approach ensures that only gamma radiation indicative of radioactive materials is detected, significantly reducing false alarms and enhancing the accuracy of detection. The systems and methods of the present specification, which are designed for high-security scanning applications, such as at ports and border crossings, are configured to efficiently scan targets such as vehicles and containers, penetrating through thick materials while accurately identifying potential threats. The systems and methods of the present specification support a more reliable, efficient, and practical solution for safeguarding against radioactive substance smuggling.

The systems and methods of the present specification are characterized by at least one of the following features and functions in some embodiments of the present specification. In some embodiments, the present invention uses statistical methods, including time-difference analysis, autocorrelation, and discrete Fourier transform, to identify the periods and phases of X-ray bursts without requiring direct communication between the X-ray generator and the gamma detector. In some embodiments, the present invention uses list-mode data acquisition, which records information about individual radiation events at the raw event-level, by employing a gamma detector that captures and stores the arrival times and/or energy (pulse height or integral) of incident photons over a specific time period. This mode enables the reconstruction of X-ray event timing from accurately time-stamped events. In some embodiments, the present invention supports autonomous detection and elimination of X-ray interference and is capable of independently identifying and discarding X-ray signatures from the gamma measurements, thus preventing interference from X-ray bursts and backscatter modulation. In some embodiments, the present invention does not require a direct hardware synchronization and is thus able to avoid logistical and technical challenges associated with hard-wiring or establishing wireless communication between the X-ray generator and the gamma detector. In some embodiments, the present invention supports enhanced detection of radioactive materials. By effectively distinguishing and eliminating X-ray bursts, the disclosed systems and methods ensure that only gamma radiation from potential radioactive materials is detected, significantly reducing the likelihood of false alarms and missed detections. In some embodiments, the present specification affords operational efficiency by reducing dead time in the scanning process and maintaining high throughput while still providing accurate detection of radioactive materials.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “scanning environment” used in this disclosure may refer to scenarios in which X-ray scanners are used in tandem with gamma detection systems in any modality such as, for example, portal, cargo, hand-held and mobile. For example, in some embodiments, a portal X-ray scanner may be deployed for scanning people, parcels, and pallets while a hand-held gamma detector may be used to simultaneously scan the target for radiation materials. In some embodiments, the X-ray scanner may be configured as a high-energy or dual-energy system for imaging cargo (including containers, vehicles and railcars) while a hand-held or fixed gamma detector may be used to simultaneously scan for radiation materials. Yet again, in some embodiments, the X-ray scanner may be deployed on a mobile inspection vehicle while the gamma detector may be hand-held or portable by way of being mounted on the inspection vehicle. In various embodiments, hand-held and portable gamma detectors may include Radionuclide Identifiers (RIDs), Backpack Radiation Detectors (BRDs), and Spectroscopic Personal Radiation Detectors (SPRDs).

The term “module” or “engine” used in this disclosure may refer to computer logic utilized to provide a desired functionality, service or operation by programming or controlling a general purpose processor. Stated differently, in some embodiments, a module or engine implements a plurality of instructions or programmatic code to cause a general purpose processor to perform one or more functions. In various embodiments, a module or engine can be implemented in hardware, firmware, software or any combination thereof. The module or engine may be interchangeably used with unit, logic, logical block, component, or circuit, for example. The module or engine may be the minimum unit, or part thereof, which performs one or more particular functions.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

### System Environment Overview

X-ray scanning systems such as, but not limited to, vehicle scanners, use X-rays, generated by an X-ray generator to screen trucks and containers for illicit or contraband materials. There is a need to simultaneously detect illicit radioactive material during the scans using radiation detection devices such as, for example, regular sensitive gamma sensors or detectors. The X-ray generators emit high-energy X-ray photons, typically between 4 MeV and 9 MeV, which is sufficiently high to penetrate thick steel plates, however, their intense emissions interfere with the co-located gamma detectors.

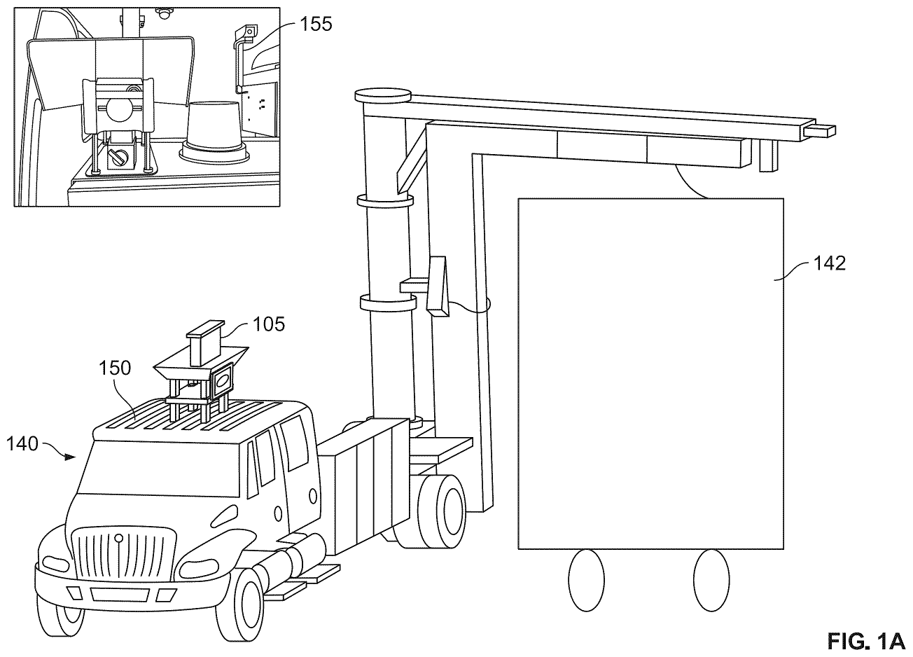

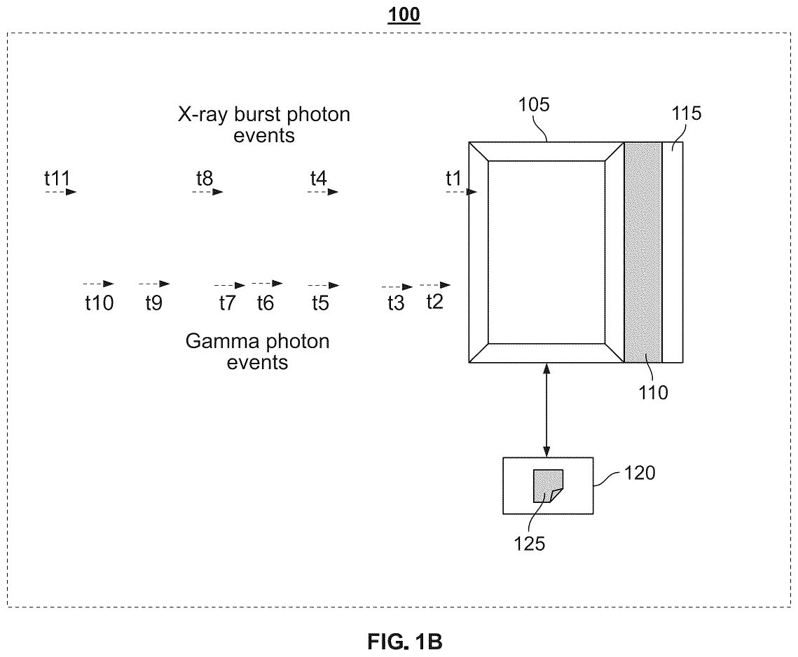

FIG. 1A shows a non-limiting exemplary scanning environment 100, in accordance with some embodiments of the present specification. Mobile X-ray scanner vehicle 140 is deployed and used for screening a cargo container truck 142. A gamma radiation detector 105 is mounted on the top of the operator cabin 150 of the mobile X-ray scanner vehicle 140. In other embodiments, as shown in 155, the gamma radiation detector 105 is mounted behind the cabin 150 of the mobile X-ray scanner vehicle 140. The X-ray scanning system (using direct and/or attenuated signals) produces scattered radiation that overlaps with and overwhelms the gamma emissions from potential radioactive materials. Thus, as described above, active X-ray scans disrupt gamma detector accuracy, making it difficult to identify illicit radioactive substances even when the gamma detectors are positioned at a safe standoff distance. In most applications the standoff distance is approximately five meters or more. An X-ray scan may also produce false gamma alarms from backscatter effects of the cargo contents and/or container materials.

FIG. 1B is a block diagram illustration of a portion of the scanning environment 100, in accordance with some embodiments of the present specification. The environment 100 includes the gamma radiation photon-counting detector 105. In embodiments, the gamma radiation detector 105 includes a plurality of detector modules 110 and associated data acquisition systems 115. The gamma radiation detector 105 is in communication with a host computing device 120 that includes a display, where scanning results may be viewed and monitored by a user. These systems are described in greater detail below.

### Detector Modules 110

In some embodiments, each of the plurality of detector modules 110 includes a plurality of detector elements or pixels. In some embodiments, each detector element or pixel is a semiconductor that, in response to incoming photons, generates a pulse that is collected by associated read-out electronics that typically perform signal amplification, discrimination, and photon-counting/analog-to-digital conversion (ADC). In some other embodiments, at least a portion of each detector element or pixel is a gas-counter. Alternatively, in some embodiments, each detector element or pixel may include, at least in part, a scintillator-based structure having a scintillator stage and a light sensor stage which are either connected to or integrated within a circuit (such as an integrated circuit). In some embodiments, the scintillator stage comprises a scintillator crystal material characterized by a rapid decay time of the photons generated within the stage. In various embodiments, the scintillator crystal may be made from an inorganic or organic material. Inorganic scintillators may be fabricated from materials such as, but not limited to, NaI, BGO, LaBr₃, CLLBC, CeBr₃, LYSO, LSO, GSO, or YAP. Organic scintillators can be fabricated as single crystals, liquids, plastics, or organic glass. A common type of organic scintillator is based on PVT (polyvinyl toluene). In various embodiments, the light sensor stage is an optical conversion stage that can provide individual photon identification. In some embodiments, the optical conversion stage includes at least one of: a photodiode, a PMT (photomultiplier tube), a SiPM (Silicon Photo-multiplier), a SDD (silicon drift detector), and APD (avalanche photo diode).

The scintillator stage receives impinging X-ray and gamma photons and, in response, generates corresponding light photons. The light photons pass through the scintillator stage and are detected by the optical conversion stage which converts them into analog electrical signals. The resulting analog signals are then transmitted to a connected data acquisition stage 115 where they are converted into digital signals.

### Data Acquisition System 115

In some embodiments, the data acquisition system 115 includes a configurable and/or programmable list-mode multi-channel analyzer (MCA). The term “multi-channel” analyzer originates from the historical method of generating energy spectra. Traditionally, an MCA would use an analog-to-digital converter (ADC) with multiple “channels” (or ADC bins) to digitize (convert) and sort the incoming analog signals. In contrast, earlier devices known as “single-channel analyzers” could only process one channel at a time, requiring repeated measurements for each individual channel. As used in the present specification, the MCA refers to a computer or a micro-controller that stores and classifies or categorizes digitized events. Unlike conventional MCAs that accumulate counts in histogram bins, a list-mode multi-channel analyzer is a data acquisition system that records each detected event individually. In list mode, the MCA captures (records) and stores detailed information for every event (detector count), producing a sequential stream of event-mode data. Each data event comprises a photon energy value, a timestamp marking its detection time, and optional metadata tags associated with the data event (such as flags for pulse pile-up events or suspected X-ray burst frequencies). These tags are generated from real-time processing by the host computing device 120, which is configured to analyze new event data. List-mode acquisition allows for post-processing and re-analysis of data. For example, it is possible to apply different energy windows, time gates, or coincidence conditions after the measurements are complete. In some embodiments, list-mode data includes at least time-averaged detector-counts aggregated over a pre-defined time interval.

During operation, the detector generates pulses for events, such as photon or particle detection, including direct, scattered, or attenuated X-ray bursts. The analog to digital converter (ADC) digitizes each pulse, converting it to a digital value representing the event's energy. The MCA then stores time-stamped list-mode data for all detected X-ray and gamma photons in a sequential memory list and transmits this data to the host computing device 120 for processing. The list of events can be stored in RAM or written directly to a hard disk or other storage device, enabling the handling of very high event rates and large datasets. Since all raw event data are preserved, users can later sort, filter, and analyze the data in various ways, such as generating histograms, applying time correlations, or extracting spectra for specific time windows or regions of interest.

When operating in list-mode, the data acquisition system 115 can report to the host computing device 120 the energy and corresponding time-stamp of each individual X-ray and gamma photon detected by the gamma radiation detector 105. In various embodiments, the time-stamps have a time resolution better than 1 millisecond (0.001 s) and preferably below 100 nanoseconds (0.00000001 s). In an embodiment, the time resolution is 20 nanoseconds. By employing list-mode data acquisition, the gamma radiation detector 105 captures and accurately timestamps photon arrivals, allowing for a reconstruction of X-ray event timing and an effective elimination of X-ray interference from gamma measurements, as discussed below.

In some embodiments, the data acquisition system 115 is configured to operate continuously, generating and recording list-mode data in real time, even as the host computing device 120 simultaneously processes the most recently acquired event data. This parallel operation (“real-time list mode”) ensures that data collection is uninterrupted and that no events are missed while the computing device performs analysis, filtering, or other processing tasks on previously acquired data. Thus, upon acquiring an event, the data is immediately analyzed in parallel while data acquisition continues uninterrupted. Based on this analysis, target data (or an event) is dynamically eliminated without halting the acquisition process. As a result, the system supports seamless, high-throughput data acquisition and analysis, enabling efficient handling of large datasets and high event rates without loss of fidelity or acquisition gaps. In other words, the operation is performed in “real-time”, wherein “real-time” operation is defined as an event being detected and eliminated in “real-time” if, upon acquiring data, that data is immediately analyzed in parallel while data acquisition continues and, based on the analysis, the target data is immediately eliminated while data acquisition continues to occur.

### Pulsed X-Ray Detection and Elimination (PXDE) Module 125

X-ray emissions occur as pulsed bursts during scanning. While hardwired synchronous blanking signals from the X-ray generator could, in theory, be used to suppress and inhibit the gamma detector 105 from counting nuisance X-ray photons during active bursts, physically or wirelessly linking the X-ray system 140 and gamma detector 105 is often impractical or impossible. Additionally, X-ray generator photons create pulse pile-up effects in scintillation detectors, interfering with accurate detection.

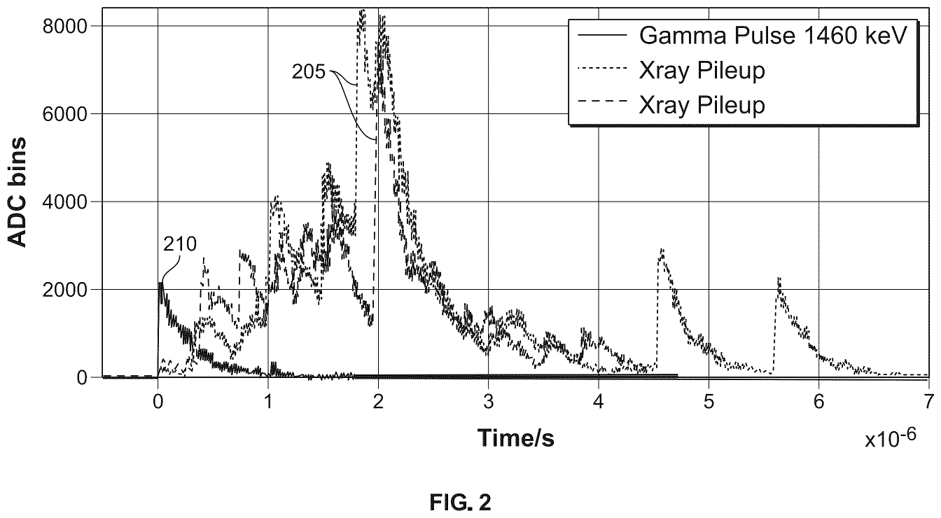

FIG. 2 is a graph that displays digitized current pulses (on the Y-axis) generated by a detector using a Bismuth Germanium Oxide (BGO) scintillator. BGO scintillators are used, among other applications, in gamma pulse spectroscopy devices. The graph distinguishes between pulses corresponding to X-ray events 205 and gamma events 210. As shown, the X-ray bursts 205 may produce significant pile-up.

Conventional pileup rejection methods, which discard overlapping events by analyzing scintillation pulse integrity, effectively filter X-rays arriving in rapid succession. While X-rays exceeding 3 MeV typically lie outside the gamma spectrum's energy range, lower-energy X-ray events (e.g., backscatter) can mimic gamma signals and evade detection via pileup rejection. These residual X-ray pulses require additional detection and elimination to prevent false alarms in gamma detection systems.

In some embodiments, the system and methods of the present specification identify X-ray photon event timing directly from gamma detector data during measurement, enabling automatic rejection of overlapping X-ray signatures without relying on cabling or external signal transmission. Accordingly, in embodiments, the host computing device 120 employs a pulsed X-ray detection (PXDE) module 125. This module is configured to process data streams containing both X-ray photon events and gamma photon events (detected by the gamma radiation detector 105), in real time, using at least one of a plurality of statistical timing analysis methods, to identify and filter out X-ray photon events. In various embodiments, the statistical timing analysis methods include autocorrelation, time-difference analysis, and discrete Fourier Transform (also referred to as, Fast Fourier Transform or FFT) methods. Each of the plurality of statistical timing analysis methods leverages the fact that X-ray machines—such as those, for example, used for vehicle scanning—produce X-ray photons that occur periodically and thus predictably at a generic frequency. Conversely, gamma events have random temporal distribution, occurring both during and between X-ray bursts.

The PXDE module 125 includes a plurality of instructions or programmatic code which, when executed, enable the host computing device 120 to analyze segments of list-mode data. This analysis identifies the period and phase angle of interfering X-ray photon events using statistical analysis timing methods. Before the very first blanking of X-ray photon bursts can occur, the PXDE module 125 determines (and is configured to do so) the period and phase angle from the data segment. In some embodiments, a minimum time-segment is at least 2/burst-frequency (also expressed as 2/bf) to establish baseline parameters. In some embodiments the predefined, yet customizable, time-segment of the list-mode data ranges from 10/bf to 1000/bf. In some embodiments, the predefined, yet customizable, time-segment of the list-mode data includes less than 1 second of list-mode data for real time operation. The accuracy of measurement of the period and phase angle may be improved with longer periods.

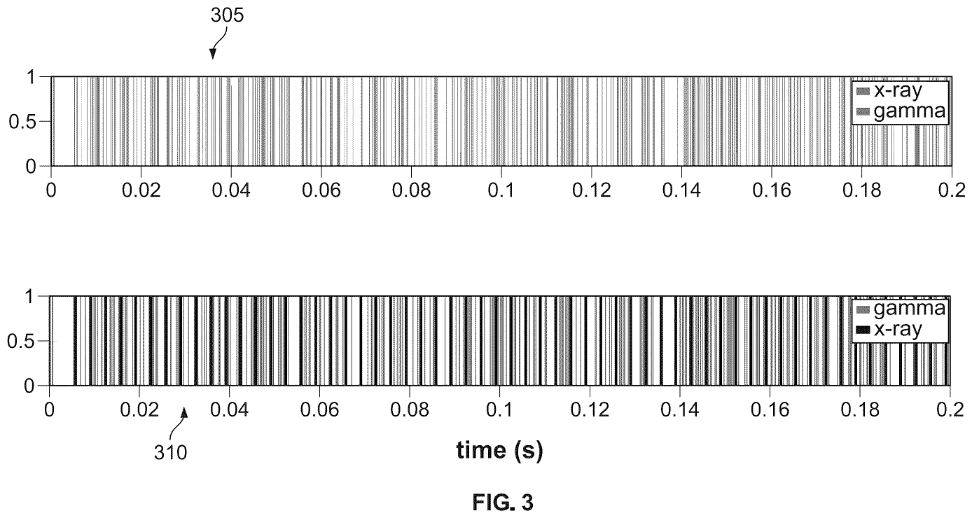

FIG. 3 illustrates two plots, wherein a first plot 305 displays vertical lines representing gamma and X-ray photon events of at least 0.2 seconds. X-rays (300 Hz frequency) and gamma rays (3,000 counts per second, random rate) are indistinguishable here, as both appear as non-dashed vertical lines. A second plot 310 highlights X-ray photon events with dashed vertical lines, showing their periodic timing and explicitly identifies X-ray bursts, which cannot be discerned through visual inspection alone compared with the first plot 305.

The PXDE module 125 is designed to detect periodic X-ray photon events embedded within a Poisson-distributed random background of gamma photon arrivals. List-mode data is acquired for a pre-defined time period by operating the gamma detector 105 using data acquisition system 115. The list-mode data is transmitted to the host computing device 120. The PXDE subsequently analyzes the list-mode data using at least one of the statistical timing analysis methods in order to determine the burst period (frequency) and phase (time offset) of interfering X-ray photon events. Using these parameters (burst period and phase), the PXDE module 125 generates autonomous blanking signals, enabling interference-free gamma event measurements by dynamically excluding X-ray pulses. The following sections demonstrate methods for detecting and inhibiting X-ray interference through simulated X-ray burst data and controlled experiments using a mechanical chopper to generate gamma pulses.

Method 1: Statistical Timing Analysis, Autocorrelation of MCS (Multichannel Scaling) Vectors from List-Mode Data

While cross-correlation typically refers to the convolution of two distinct random vectors, the present specification focuses on auto-correlation, whereby time-shifted segments of the same dataset are analyzed. In a non-limiting example, each vector element represents gamma detection counts sampled over consecutive 1 s intervals. It is observed that most of the 1 s samples are empty and just a few randomly hold one or two events. However, during active X-ray pulsing, photon detections exhibit a periodic spike every 333 s (on average, which represents a multiple of the typical frequency of the pulsed x-ray generator) with a much higher probability than at other random times. The periodic spike may be observed at a regular interval that ranges from 10 s to 10000 s, while at a specific frequency, thus matching a resonance of the x-ray generator. The autocorrelation result is computed by calculating the scalar product of the count-sample vector with progressively time-shifted versions of itself. A 333-sample shift yields a stronger contribution to the autocorrelation value than other shifts.

The detection times or event arrival times are provided as random vector

$$t := [ {t}_{1} , {t}_{2} , {t}_{n} ] \qquad ( 1 )$$

Detections are recorded in histogram channels, which is the same as collecting counts in consecutive samples, known as multichannel scaling, MCS. The MCS vector is now defined as histogram ‘h’ with ‘m’ elements of the detection and counting process hᵢ

$$h := [ {h}_{1} , {h}_{2} , … … {h}_{m} ] with {h}_{i} := {\sum }_{j = 1}^{n} {\int }_{i \cdot Δ}^{i \cdot ( Δ + 1 )} δ ( {t}_{j} - {t}^{′} ) {dt}^{′} \qquad ( 2 )$$

The integral over the delta function produces one “count” whenever tⱼ is in a sampling period Δ, between i·Δ and i·Δ+Δ. In the current exemplary simulation, a 200 ms duration is covered, segmented into discrete time intervals with a granularity of Δ=1 μs, so that h consists of n=2×10⁵ samples. The autocorrelation Rₕₕ of h is defined as:

$${R}_{hh} := [ {R}_{hh} ( ‐ m ) , … … , {R}_{hh} ( - 1 ) , {R}_{hh} ( 0 ) , {R}_{hh} ( 1 ) , … … , {R}_{hh} ( m ) ] \qquad ( 3 )$$

$$with {R}_{hh} ( j ) := \{ \begin{matrix}{\sum }_{i = 0}^{m - j - 1} {h}_{i} + {}_{j} {h}_{i} & : j \geq 0 \\ {R}_{hh} ( - j ) & : j < 0\end{matrix} \qquad ( 4 )$$

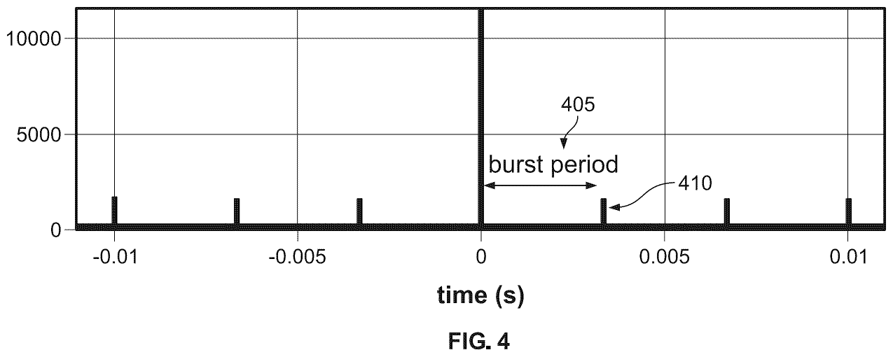

FIG. 4 is a histogram showing the burst frequency f=1/T (T=burst period) which is determined via autocorrelation analysis of time-series count samples, in accordance with some embodiments of the present specification. The figure shows time in seconds (s) along the x-axis and square of the count along the y-axis. Consequently, referring to FIG. 4, the X-ray burst period 405 (and thus the frequency, where frequency=1/T, where T is the burst period) can be determined by measuring the interval between the peaks (maxima) of the autocorrelation function Rₕₕ. For simplicity, the interval is often chosen as the distance can be picked between Rₕₕ(0) and the next nearest maximum 410.

### Method 2: Statistical Timing Analysis, Event Time-Difference Analysis

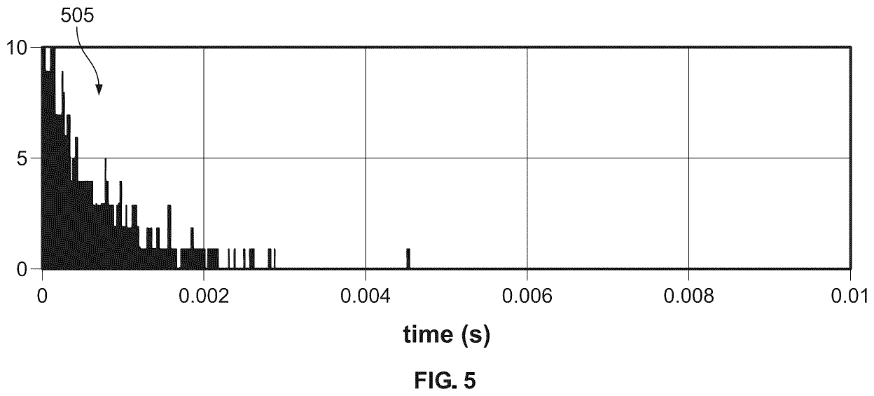

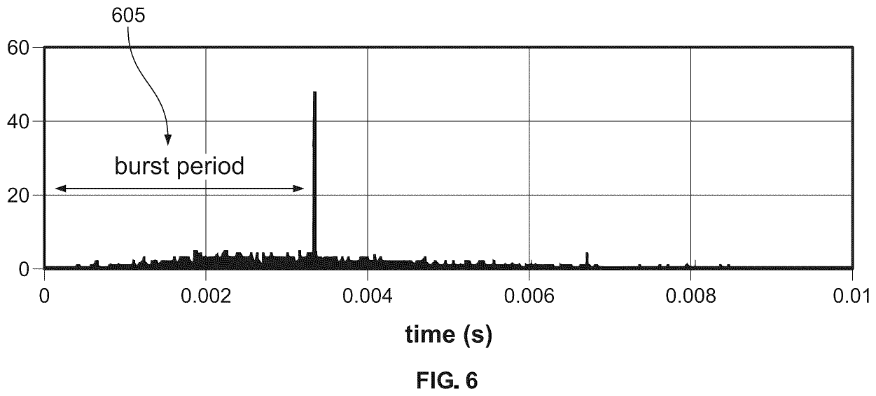

A second method of identifying the X-ray-burst frequency analyzes the time-difference distribution between detected events. As shown in FIG. 5, time intervals between two neighboring (consecutive) random events follow an exponential distribution 505. X-ray burst periods do not prominently appear in this distribution, especially when gamma event rates are high, as gamma events often occur between X-ray bursts. However, as shown in FIG. 6, when time intervals or differences between multiple events (for example, three or more) is evaluated, the X-ray-burst period 605 emerges as more likely a difference with statistical significance, occurring more frequently than random intervals of the same duration.

In general, the time difference between ‘m’ random events exhibit an Erlang distribution. D^{m}(tᵥ) denotes the m^{th} time difference of the event ‘v’:

$${D}^{0} ( {t}_{v} ) = {t}_{v} {D}^{1} ( {t}_{v} ) = {t}_{v} - {t}_{v - 1} {D}^{m} ( {t}_{v} ) = {t}_{v} - {t}_{v - m} \qquad ( 5 )$$

Random event time differences are Erlang (denoted with Γ) distributed with the typical shape of a fast rising and slowly decaying curve.

$${D}^{m} ( {t}_{v} ) - ( Γ , λ , m ) \qquad ( 6 )$$

When ‘m’ is chosen as the floor of count rate ratios:

$$m = [ ( {λ}_{gamma} + {λ}_{x - ray} ) / {λ}_{x - ray} ] \qquad ( 7 )$$

Periodic non-random events disrupt the Erlang distribution pattern, manifesting as statistical outliers at time intervals matching the periodic events, such as in the current example of shape m=7, gamma event rate λ_{gamma}=2000 Hz, and X-ray burst period T_{X-ray}=333 μs.

### Localization of Pulsed X-Rays

The X-ray burst frequency f=1/T (T=burst period) that can be determined (for the first and second statistical timing analysis methods) is not sufficient to localize the X-ray bursts and construct a blanking signal. To accurately localize past and future X-ray bursts, the phase, or the temporal relation between burst timing and event detection must also be determined.

Frequency, phase, and duration are critical parameters used to generate the blanking signal. While neither autocorrelation (first method) nor time-difference analysis (the second method) yields the phase directly, using a two-step approach resolves this. Thus, in some embodiments, after the X-ray burst frequency has been determined by either the first method or the second method, the phase is determined by computing the cross-correlation between the detector signal ‘h’ and the regularly patterned periodic ‘k’ that is generated at the frequency identified. The cross-correlation identifies the phase by aligning ‘k’ with ‘h’.

The period signal ‘k’ is defined similar to ‘h’, replacing the event arrivals tᵢ by the repetitive time i/f.

$$k := [ {k}_{1} , {k}_{2} , … ¨ {k}_{m} ] with {k}_{i} := {\sum }_{j = 1}^{n} {\int }_{i \cdot Δ}^{i \cdot ( Δ + 1 )} δ ( \frac{i}{f} - {t}^{′} ) {dt}^{′} \qquad ( 8 )$$

The cross-correlation of h and k is defined as:

$${R}_{hk} := [ {R}_{hk} ( - m ) , … ¨ , {R}_{hk} ( - 1 ) , {R}_{hk} ( 0 ) , {R}_{hk} ( 1 ) , … ¨ {R}_{hk} ( m ) ] \qquad ( 9 )$$

$$with {R}_{hk} ( j ) := \{ \begin{matrix}{\sum }_{i = 0}^{m - j - 1} {h}_{i} + {}_{j} {h}_{i} & : j \geq 0 \\ {R}_{hh} ( - j ) & : j < 0\end{matrix} \qquad ( 10 )$$

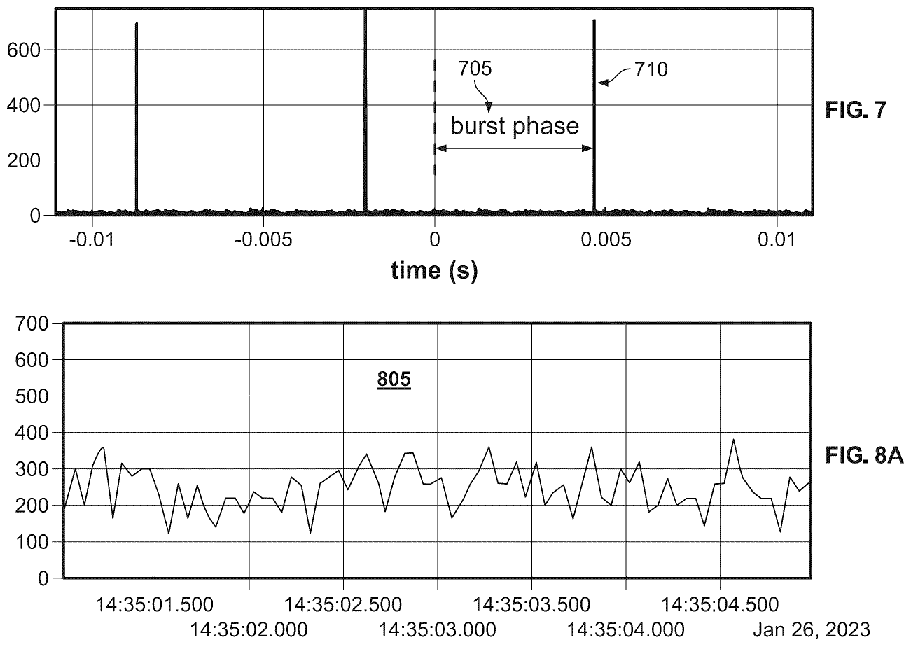

As shown in FIG. 7, the phase value is determined by measuring the distance 705 from the origin (zero) to the first local maximum 710 in the cross-correlation result. This distance 705 represents the temporal offset of the X-rays bursts relative to the detector's timing reference.

### Method 3: Statistical Timing Analysis, Discrete Fourier Transform Analysis of Pulsed Radiation

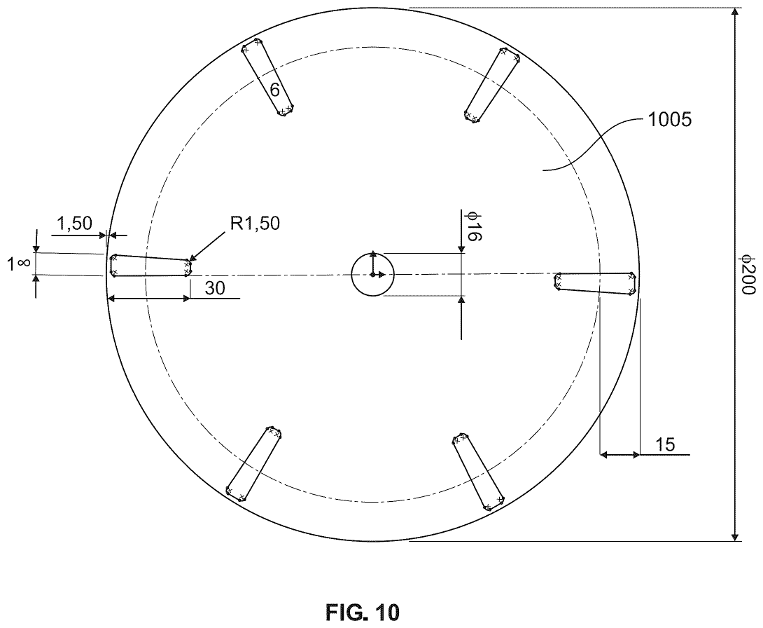

The autocorrelation (first method) and event time-differencing (second method) were tested using simulated data with mixed random (gamma-like) and periodic (X-ray-like) signals and experimental data from a chopped radiation source, to emulate X-ray bursts. While both methods proved functional, they still exhibit a reduced accuracy of the frequency estimates. A mechanical chopper/shutter can be used to generate pulsed radiation fields, which opens the path from a radioactive source to the detector and periodically modulates radiation exposure for short durations. In embodiments, a rotating slotted disk is employed. In one embodiment, a 5 mm steel disk with two opposing slots is used. At a speed of 3,000 rpm (50 rotations/second), the slots aligned with the detector twice per rotation, produce 100 Hz bursts on the order of a few milliseconds. In one embodiment, as shown in FIG. 9, a modified table saw 905 is used as a 100 Hz beam chopper for 242Am 60 keV gamma radiation. In another embodiment, a modified blade with six equidistant slots, as shown in FIG. 10, is used to generate 300 Hz bursts, which is the same frequency that is used for pulsed X-ray bursts. A ²⁴¹Am source (60 keV gamma emissions) is selected for its emission of low-energy photons, which are easily shielded.

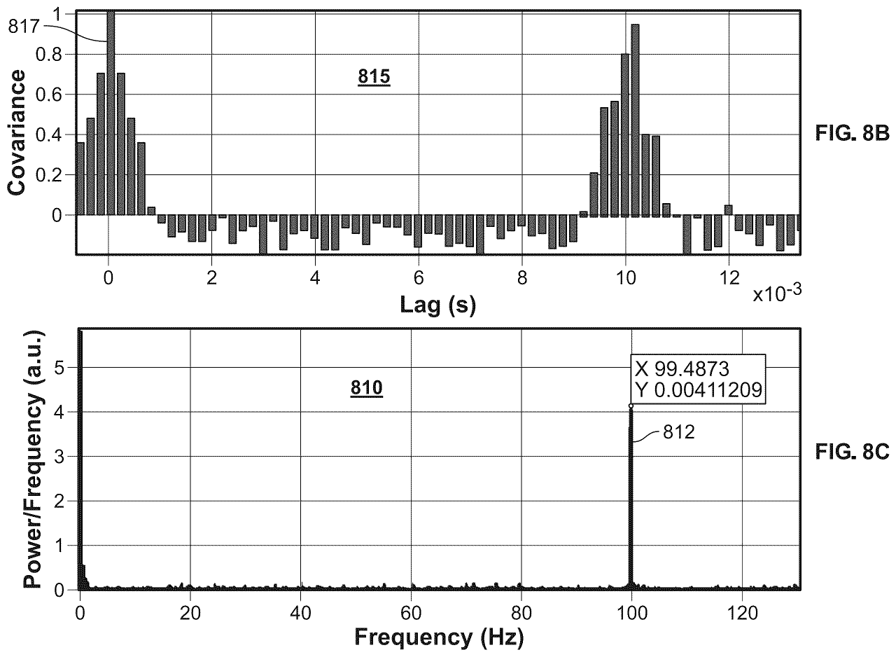

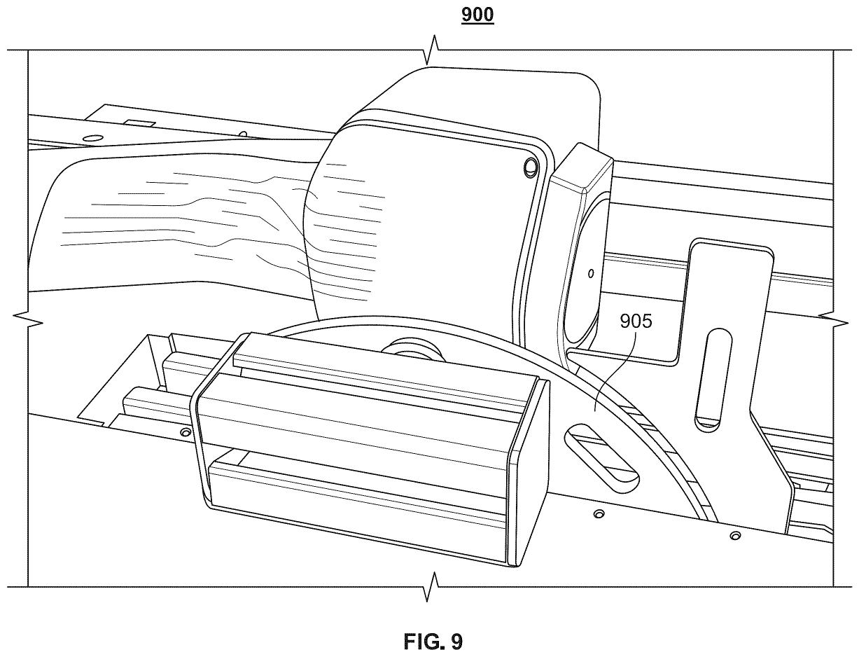

FIG. 8A is a first graph of five seconds of multi-channel scaling (MCS) data, showing mechanically chopped ²⁴¹Am gamma radiation (or periodically modulated gamma emissions) at a frequency of 100 Hz, in accordance with some embodiments of the present specification. FIG. 8B is a second graph using the auto-covariance of mechanically chopped ²⁴¹Am gamma radiation (or periodically modulated gamma emissions) at a frequency of 100 Hz, in accordance with some embodiments of the present specification. FIG. 8C is a third graph showing a periodogram of mechanically chopped ²⁴¹Am gamma radiation (or periodic modulation of gamma emissions) at a frequency of 100 Hz, in accordance with some embodiments of the present specification.

Referring to FIGS. 8A, 8B, and 8C simultaneously, as shown in a first plot 805, only a Gaussian fit could produce the period with sufficient accuracy for five seconds of multi-channel scaling (MCS) data, produced by mechanically chopped ²⁴¹Am gamma radiation (or periodically modulated gamma emissions) at a frequency of 100 Hz, generated from the list-mode time-stamps in accordance with Equation 2 above. Autocorrelation imposes a numerical operation on the scale of the square of the vector length, creating a significant processing and computational overhead. When monitoring a pulsed radiation source (e.g., chopped 241Am gamma radiation at 100 Hz), MCS data shows the count rate as a function of time, revealing the periodic structure of the radiation pulses.

While the Fourier transform is typically used for continuous, smooth signals it can be applied to any signal. The discrete Fourier transform (DFT) has significant practical advantages, with reference to the present specification, particularly for analyzing discrete periodic signals such as Dirac-comb-like structures representing pulsed X-ray bursts. As shown in FIG. 8C, the benefits are evident when considering a power spectrum density (PSD) estimation of the multichannel-scaling (MCS) vector represented by periodogram 810. Due to the signal energy being concentrated at a discrete frequency (here, 100 Hz), the periodogram 810 exhibits sharp peaks (such as peak 812) at this frequency. FIG. 8B illustrates an auto-covariance plot 815 (a normalized version of autocorrelation) of the five seconds of MCS (multi-channel scaling) data. As illustrated by plot 815 while autocorrelation can identify the burst frequency, the broad peaks introduce high statistical uncertainty. As the centroid positions need to be determined more accurately, supplemental computational methods, such as DFT, would be required, incurring additional computational costs.

The PSD represents a) the Fourier transform of the autocorrelation and b) is equivalent to the square of the Fourier transform. Using the Fast Fourier Transform, W(f), the periodogram P(f) becomes:

$$W ( f ) = {\sum }_{n = 0}^{N - 1} {x}_{n} {e}^{- j 2 π f Δ tn} ; \hat{P} ( f ) = \frac{Δ t}{N} {\vert {\sum }_{n = 0}^{N - 1} {x}_{n} {e}^{- j 2 π f Δ tn} \vert}^{2} \qquad ( 11 )$$

thereby, avoiding the computation-heavy autocorrelation prior to the Fourier transform. The Fourier transform enables the identification of periodic patterns within random event data (by converting time-domain signals into frequencies, where periodicities emerge as distinct spectral peaks). Additionally, since no autocorrelation needs to be calculated, the computational load is decreased. The fast Fourier transform (FFT) requires only nlog₂n operations, saving more than 99% computing power when the MCS vector to be analyzed has 4096 elements.

As shown in FIG. 8B, the autocorrelation peak 817, near 0.01 seconds, requires curve fitting to eliminate burst frequency due to its broad profile. In contrast, periodogram 810 (power spectral density) is so narrow (sharp spectral peak 812) that the associated radiation burst frequency can be found and extracted directly with high precision.

In some embodiments, the FFT not only generates a periodogram identifying the radiation burst frequency but also extracts the phase angle associated with the identified frequency, which enables temporal alignment of blanking signals, critical for suppressing periodic X-ray interference in gamma spectroscopy systems. Using Equation 11, above, the burst frequency f_{burst} can be determined at the maximum of the periodogram with the corresponding phase angle θ_{burst}, as follows:

$${f}_{burst} = arg {max}_{f} \hat{} P ( f ) \qquad ( 12 )$$

$$and the phase angle {θ}_{burst} = {tan}^{- 1} [ Im W ( {f}_{burst} ) / Re W ( {f}_{burst} ) ] \qquad ( 13 )$$

and using Equations 12 and 13, above, the gammas event times tᵢ(gamma) can be tagged in the list-mode data stream ‘t’ defined in equation 1 using modular division denoted by #

$$\begin{matrix}( {t}_{i} + \frac{{θ}_{burst}}{2 π {f}_{burst}} ) \# \frac{1}{{f}_{burst}} > \frac{K}{{f}_{burst}} ⇒ {t}_{i} = {t}_{i} ( gamma ) \\ ⇔ \\ ( {t}_{i} {f}_{burst} + \frac{{θ}_{burst}}{2 π} ) \#1 > K ⇒ {t}_{i} = {t}_{i} ( gamma )\end{matrix} \qquad ( 14 )$$

with the threshold κ cutting off the time segment's fraction that contains X-ray pulses. Kappa (κ) determines the fraction of events that are cut out. Value of κ is chosen between 0 and 1. In one example, K=0.2 implies that 20% of the events are cut out. The x-ray burst frequency is not 100% stable but may have a “jitter”. Also the frequency of the x-ray burst may be slightly misaligned and can be only measured with an error margin. The error margin of the frequency and phase measurement described above determines the value chosen for κ. κ addresses the overall accuracy limits and jitter, and can be chosen accordingly. Any arrival time tᵢ that satisfies the inequality criteria in Equation 14 is exclusively classified as a gamma event, ensuring no X-ray interference is misidentified. In the chopper radiation beam experiment, a value of κ=30% together with a phase re-calculation every 0.5 seconds removed the potential burst events completely.

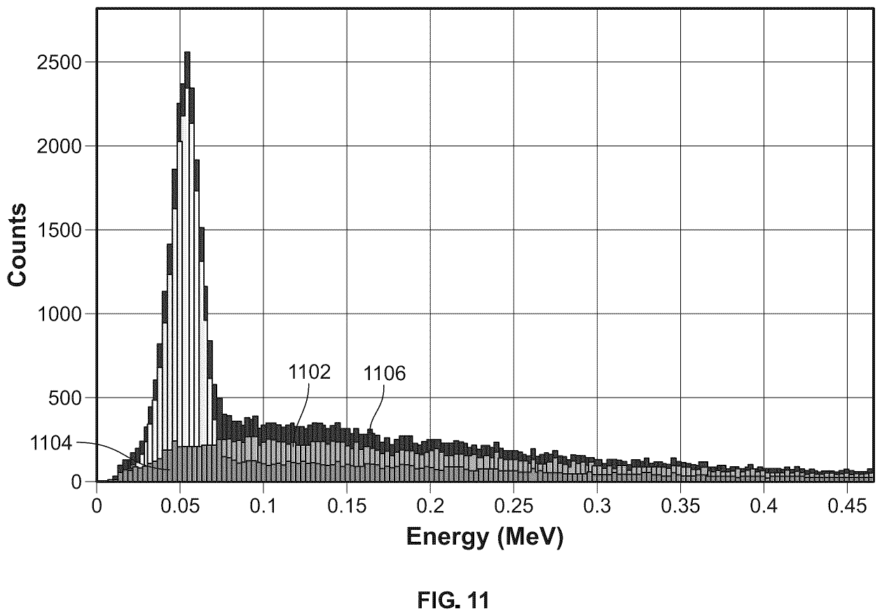

FIG. 11 shows results of the 300 Hz circular saw chopper experiment described above. The gamma background is shown as the shaded plot 1102, the excluded X-ray bursts are shown as plot 1104, and the unfiltered spectrum without discrimination appears as plot 1106.

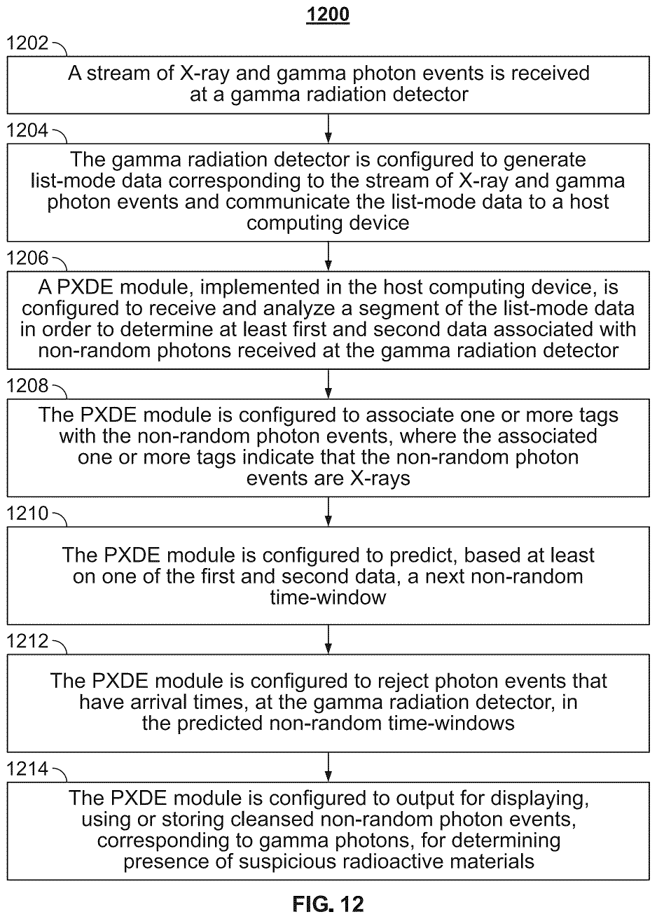

FIG. 12 illustrates a flowchart of a multi-step process 1200 for detecting and eliminating X-ray photon events from a mixed stream of X-ray and gamma photon events detected by the gamma radiation detector 105, in accordance with some embodiments of the present specification. Referring now to FIGS. 1B and 12, in various embodiments, the PXDE module 125 contains a plurality of instructions or programmatic code that, when executed, causes the host computing device 120 to implement the method 1200 in real time.

At step 1202, a stream of X-ray and gamma photon events is detected by the gamma radiation detector 105.

At step 1204, the gamma radiation detector 105 generates list-mode data corresponding to the stream of X-ray and gamma photon events and transmits the list-mode data to the host computing device 120.

At step 1206, the PXDE module 125, implemented in the host computing device 120, receives and analyzes a segment of the list-mode data to determine at least first data and second data associated with non-random photons received at the gamma radiation detector 105. In other words, PXDE module 125 analyzes a segment of list-mode data to identify and quantify periodic X-ray photon events, specifically extracting their burst frequency (first data) and phase angle (second data) within the signal stream of the gamma radiation detector 105. In some embodiments, the MCS data, generated based on the list-mode data, is analyzed in order to determine the first data and the second data associated with non-random photons received at the gamma radiation detector 105. In embodiments, the PXDE module 125 is configured to apply at least one of a plurality of statistical timing analysis methods as described above to determine the first data and the second data related to the non-random photon events. In various embodiments, the plurality of statistical timing analysis methods include autocorrelation, time-difference analysis and discrete Fourier Transform (also referred to as, Fast Fourier Transform or FFT) methods.

At step 1208, the PXDE module 125 associates identified periodic X-ray events with at least one metadata tag based on the extracted burst frequency (first data) and phase (second data). The tags classify the events as X-rays, enabling real-time exclusion. A frequency tag, associated with an event, is indicative that the event may be part of a frequency that is suspected to be an X-ray burst frequency. Similarly, a phase tag, associated with an event, is indicative that the event may be part of a phase that is suspected to be associated with that of an X-ray photon. In embodiments, there are other types of tags that denote, but are not limited to, pile-up events, neutron events, cosmic-ray events, PMT-after-pulse events, among other classification tags such as, for example, alarm threshold triggers and background classifiers.

At step 1210, the PXDE module 125 predicts the next X-ray burst window using at least one of the previously determined first data and/or second data. This prediction identifies the temporal interval during which X-ray photons are likely to arrive at the gamma detector.

At step 1212, the PXDE module 125 rejects photon events detected at the gamma radiation detector 105 that have arrival times within the predicted X-ray burst windows, thereby suppressing X-ray interference.

At step 1214, the PXDE module 125 outputs clean gamma photon data (free of X-ray interference) for display, analysis, or storage. This dataset enables accurate identification of illicit radioactive materials by isolating gamma spectral signatures.

Persons of ordinary skill in the art would appreciate that conventional gamma detectors suffer from high false alarm rates when deployed near active X-ray systems due to overlapping photon signatures. The systems and methods disclosed herein resolve this by rendering gamma detectors immune to X-ray interference, ensuring radiation measurements remain accurate even in environments with concurrent X-ray scanning. The systems and methods of the present specification significantly enhance the functionality and usability of gamma detection instruments, including handheld and portable gamma detectors such as, for example, Radionuclide Identifiers (RIDs), Backpack Radiation Detectors (BRDs), and Spectroscopic Personal Radiation Detectors (SPRDs), especially in environments where X-ray scanning is concurrently taking place. By implementing the systems and methods of the present specification, gamma radiation detection devices are equipped to autonomously distinguish between gamma radiation and interference caused by X-ray bursts, in real-time, a capability that fundamentally changes their operational effectiveness and scope of use.

Specifically, the systems and methods of the present specification provide at least following operational advantages. By affording the capability to autonomously distinguish X-ray interference from gamma radiation, the technology eliminates false alarms caused by pulsed X-ray scanners. This resolves a limitation of traditional gamma detectors, which cannot differentiate between X-ray and gamma photon events, restricting their use in environments with active X-ray systems (for example at ports and border crossings).

In embodiments, the systems and methods of the present specification support expanded operational use and deployment of gamma detectors in high-interference environments. Radionuclide Identifiers (RIDs), Backpack Radiation Detectors (BRDs), and Spectroscopic Personal Radiation Detectors (SPRDs) equipped with this innovation can now operate reliably in settings where X-ray scanners are active, such as airports, border crossings, and cargo facilities.

The systems and methods of the present specification deliver operational efficiency by enabling gamma detectors to operate without interruption during concurrent X-ray scanning and helps enable resource optimization.

In embodiments, the systems and methods of the present specification offer a cost-effective approach to radiation detection. By reducing false alarms and increasing detection accuracy, users save both time and resources that would other be spent on unnecessary follow-up investigations, while improved accuracy ensures that threats are detected and addressed promptly.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A gamma detection system, comprising:
a gamma detector configured to receive a stream of X-ray and gamma photon events, wherein the gamma detector comprises a plurality of detector modules;
at least one data acquisition system in data communication with each of the plurality of detector modules, wherein the at least one data acquisition systems is configured to generate list-mode data corresponding to the stream of X-ray and gamma photon events;
a computing device in communication with the at least one data acquisition system, wherein the computing device comprises a processor and a non-volatile memory for storing a plurality of programmatic instructions which, when executed, cause the processor to:
receive the list-mode data;
apply at least one statistical timing analysis method to a segment of the list-mode data to determine at least first data and second data associated with X-ray photon events received at the gamma detector;
tag the at least first data and second data with the X-ray photon events;
predict, based on one of the at least first data and second data, a next time window of arrival of an X-ray photon event at the gamma detector;
reject photon events that have arrival times at the gamma detector in the predicted time window; and
output data indicative of gamma photon events.

2. The gamma detection system of claim 1, wherein the at least one statistical timing analysis method comprises at least one of an autocorrelation method, a time-difference method, and a discrete Fourier Transform method.

3. The gamma detection system of claim 1, wherein the first data is indicative of a frequency of the X-ray photon events and the second data is indicative of a phase angle of the X-ray photon events.

4. The gamma detection system of claim 3, wherein, when executed, the plurality of programmatic instructions cause the processor to determine the frequency and the phase angle by utilizing a power density spectrum of said segment of the list-mode data.

5. The gamma detection system of claim 1, wherein the gamma detection system is a handheld device or a portable device.

6. The gamma detection system of claim 1, wherein the X-ray photon events result from direct, scattered and/or attenuated X-ray bursts.

7. The gamma detection system of claim 1, wherein the list-mode data comprises at least a first value indicative of photon energy and a second value indicative of a time of detection of a photon.

8. The gamma detection system of claim 1, wherein the data acquisition systems comprise list-mode multi-channel analyzers.

9. The gamma detection system of claim 1, wherein the segment corresponds to less than 1 second of the list-mode data.

10. A computer-implemented method of detecting and eliminating, in real-time, X-ray photon events from a stream of X-ray and gamma photon events arriving at a gamma radiation detector, wherein the gamma radiation detector comprises a plurality of detector modules and associated data acquisition systems, comprising:
generating list-mode data corresponding to the stream of X-ray and gamma photon events, wherein the list-mode data is generated by the data acquisition systems coupled to the plurality of detector modules;
receiving the list-mode data in a computing device that is in data communication with the gamma radiation detector;
using the computing device, applying at least one statistical timing analysis method to a segment of the list-mode data in order to generate at least first data and second data associated with X-ray photon events received at the gamma radiation detector;
tagging the at least first data and second data with data indicative of the X-ray photon events;
predicting, based on one of the at least first data and second data, a next time window of arrival of an X-ray photon event at the gamma radiation detector;
rejecting photon events that have arrival times at the gamma radiation detector in the predicted time window; and
outputting data without said photon events.

11. The computer-implemented method of claim 10, wherein the at least one statistical timing analysis method comprises at least one of an autocorrelation analysis, a time-difference analysis, and a discrete Fourier Transform analysis.

12. The computer-implemented method of claim 10, wherein the first data is indicative of a frequency of the X-ray photon events and the second data is indicative of a phase angle of the X-ray photon events.

13. The computer-implemented method of claim 12, further comprising determining the frequency and the phase angle by analyzing a power density spectrum of the segment of the list-mode data.

14. The computer-implemented method of claim 10, wherein the gamma radiation detector is configured as a handheld device or a portable device.

15. The computer-implemented method of claim 10, wherein the X-ray photon events result from direct, scattered and/or attenuated X-ray bursts.

16. The computer-implemented method of claim 10, wherein the list-mode data comprises at least a first value indicative of a photon energy of at least one of the X-ray photon events and a second value indicative of a time of detection of a photon from at least one of the X-ray photon events.

17. The computer-implemented method of claim 10, wherein the data acquisition systems comprises one or more list-mode multi-channel analyzers.

18. The computer-implemented method of claim 10, wherein the segment corresponds to less than 1 second of the list-mode data.

19. A radiation detection device, comprising:
a gamma detector configured to receive a stream of non-random and random photon events and generate corresponding list-mode data;
a computing device in communication with the gamma detector, wherein the computing device includes a processor and a non-volatile memory for storing a plurality of programmatic instructions which, when executed, cause the processor to:
receive the list-mode data;
cause at least one statistical timing analysis to be applied to a segment of the list-mode data to determine a first data and a second data associated with the non-random photon events;
predict, based at least on the first data and the second data, a next non-random time window; and
reject photon events that have arrival times at the gamma detector in the predicted non-random time window.

20. The radiation detection device of claim 19, wherein the at least one statistical timing analysis comprises an autocorrelation analysis, a time-difference analysis, and a discrete Fourier Transform analysis.

21. The radiation detection device of claim 19, wherein the first data is indicative of a frequency of the non-random photon events and the second data is indicative of a phase angle of the non-random photon events.

22. The radiation detection device of claim 21, wherein the frequency and phase angle are determined by analyzing a power density spectrum of the segment of the list-mode data.

23. The radiation detection device of claim 19, wherein the radiation detection device is a handheld device or a portable device.

24. The radiation detection device of claim 19, wherein the non-random photon events correspond to direct, scattered and/or attenuated X-ray bursts, and wherein the random photon events correspond to gamma radiation.

25. The radiation detection device of claim 19, wherein the list-mode data comprises at least a first value indicative of photon energy of the non-random photon events and a second value indicative of a time of detection of a photon of the non-random photon events.

26. The radiation detection device of claim 19, wherein the segment corresponds to less than 1 second of the list-mode data.
